(19) United States
(12) Patent Application Publication
(10) Pub. No.: US 2016/0082795 A1
(43) Pub. Date: Mar. 24, 2016

(54) FASTENING DEVICE FOR FASTENING TRAILER CONNECTORS

(71) Applicant: WEN-CHUN SU, TAICHUNG CITY (TW)

(72) Inventor: WEN-CHUN SU, TAICHUNG CITY (TW)

(21) Appl. No.: 14/548,763

(22) Filed: Nov. 20, 2014

(30) Foreign Application Priority Data
Sep. 23, 2014 (TW) 103132763

(51) Int. Cl. B60D 1/36; B60D 99/00

(52) U.S. Cl. CPC B60D 1/363; B60D 7/00

(57) ABSTRACT

A fastening device for fastening trailer connectors includes a hitch penetrating through the trailer connectors. The hitch has a first locating member detachably connected to the hitch for preventing the hitch from coming off the trailer connectors and a second locating member having a first combining portion and a second combining portion. The first combining portion is movably connected to the first locating member, so as to allow the second locating member to shift between a locked position and an unlocked position. At the locked position, the second locating member has the second combining portion fixed to the hitch by a fixing member so as to hold the first locating member in engagement with the hitch. At the unlocked position, the second locating member has the second combining portion removed from the hitch so as to allow the first locating member to be detached from the hitch.

### BACKGROUND OF THE INVENTION

1. Technical Field

The present invention relates to trailer-connecting structures for vehicles, and more particularly to a fastening device for fastening trailer connectors, wherein the fastening device is easy to lock and unlock.

2. Description of Related Art

In order to increase the capacity for carrying people and articles, many people attach trailers behind their vehicles using connectors and fastening devices. Some of such fastening devices are described in prior patents and applications such as US Patent Application No. US 20120212000 titled “Trailer Lock”, U.S. Pat. No. 6,364,339 titled “Trailer Hitch and Lock Assembly”, U.S. Pat. No. 6,402,181 titled “Trailer Hitch and Lock Assembly”, among others. Most of these known devices have a hitch and a lock. The hitch is configured to penetrate trailer connectors with a terminal of the hitch extends outside the trailer connectors. The terminal of the hitch is provided with an engaging portion. The lock has a mounting hole, an engaging member and a lock hole. The mounting hole is mounted around the terminal of the hitch, and the lock hole receives a key to insert therein and rotate so as to drive the engaging member to engage with the engaging portion, thereby locking the hitch.

However, such a prior art device involves using a key to lock and unlock a lock, which is complicated and inconvenient. Besides, the lock includes many and various components, so is structurally complicated and difficult to fabricate. This fact causes the overall manufacturing costs and in turn the selling price to be undesirably high.

There are also fastening devices without any lock cylinders. As one example, Taiwan Patent No. M274264 titled “Vehicle Trailer Lock” provides a device having a hitch that includes an engaging rod and a spring. The spring props up a lock block to get engaged with the engaging rod, thereby positioning the lock block with respect to the hitch. However, for working with the engaging rod and the spring, the hitch is a customized one but not one with the standard specifications, so the manufacturing costs are still high.

### SUMMARY OF THE INVENTION

Hence, the inventor herein provides a fastening device for fastening trailer connectors, wherein the fastening device is structurally simplified and a hitch of the standard specifications can be used. The fastening device comprises a hitch and a locating assembly. The hitch is configured to penetrate the trailer connectors. The locating assembly includes a first locating member and a second locating member. The first locating member is detachably connected to the hitch for preventing the hitch from coming off the trailer connectors. The second locating member has a first combining portion and a second combining portion, wherein the first combining portion is movably connected to the first locating member, so as to allow the second locating member to shift between a locked position and an unlocked position. When the second locating member is at the locked position, the second combining portion of the second locating member is fixed to the hitch by a fixing member and thus holds the first locating member in engagement with the hitch. When the second locating member is at the unlocked position, the second combining portion of the second locating member is removed from the hitch and thus allows the first locating member to be detached from the hitch.

Further, the first combining portion of the second locating member is slidably connected to the first locating member by a fixing pin.

Further, the hitch is provided with an engaging groove, and the first locating member of the locating assembly is provided with a pair of engaging portions that define therebetween a notch and an opening communicated with the notch. When the hitch is placed into the first locating member through the opening with the engaging groove aligned with the notch, the hitch is engaged with the first locating member.

Further, the hitch includes a terminal, and the second locating member of the locating assembly includes a sleeve portion that is configured to be mounted around the terminal of the hitch and thereby hold the second locating member at the locked position.

Further, the fixing member is a fastener or a magnet.

Further, the hitch further has a retaining groove, and the second locating member has a breach and the fixing member, in which the fixing member is a wire snap. The wire snap has a pair of gripping portions and a flexible portion that is connected between the gripping portions, so that a receiving space is defined amid the gripping portions and the flexible portion for fittingly receiving the second locating member. When the second locating member is at the locked position, the gripping portions enter the retaining groove through the breach to get engaged.

Further, the locating assembly further comprises a casing that is configured to be mounted around the second locating member for shielding the wire snap.

Further, the casing is provided with a plurality of anti-slip portions.

The present invention also provides a fastening device for fastening trailer connectors which are penetrated by a hitch. The fastening device includes a first locating member and a second locating member. The first locating member is detachably connected to the hitch for preventing the hitch from coming off the trailer connectors. The second locating member has a first combining portion and a second combining portion. The first combining portion is movably connected to the first locating member, so as to allow the second locating member to shift between a locked position and an unlocked position. When the second locating member is at the locked position, the second combining portion of the second locating member is fixed to the hitch by a fixing member and thus holds the first locating member in engagement with the hitch. When the second locating member is at the unlocked position, the second combining portion of the second locating member is disengaged from the hitch and thus allows the first locating member to be detached from the hitch.

The present invention has the following virtues:

1. The locating assembly is attached and affixed to the hitch by means of the first and second locating members that are movably connected to each other and sequentially mounted to the hitch, thereby eliminating the use of the lock cylinder that needs a key for locking or unlocking. This makes its use more convenient and since its structure is relatively simple, the manufacturing costs can be reduced.

2. The locating assembly may be realized by a conventionally structured hitch, so the product has excellent applicability.

3. Since the locating assembly can be fixed by means of magnetism, its fixation is less likely to be adversely affected by external dust and dirt.

4. Since the locating assembly is fixed by means of magnetism as well as the wire snap, it is better positioned without the risk of unintentionally unlocking.

### BRIEF DESCRIPTION OF THE DRAWINGS

FIG. 1 is a schematic exploded view of a first embodiment of the present invention.

FIG. 2 is a schematic perspective view of the first embodiment of the present invention.

FIG. 3 is a schematic view showing the operation state of the first embodiment of the present invention, wherein the locating assembly is not yet mounted to the hitch.

FIG. 4 is also a schematic view showing the operation state of the first embodiment of the present invention, wherein the first locating member of the locating assembly has been engaged with the hitch, while the second locating member is at the unlocked position.

FIG. 5 is still a schematic view showing the operation state of the first embodiment of the present invention, wherein the first locating member and the second locating member of the locating assembly are both fixed to the hitch as the second locating member is at the locked position.

FIG. 6 is a schematic perspective view of the first embodiment of the present invention, wherein the locating assembly is locked.

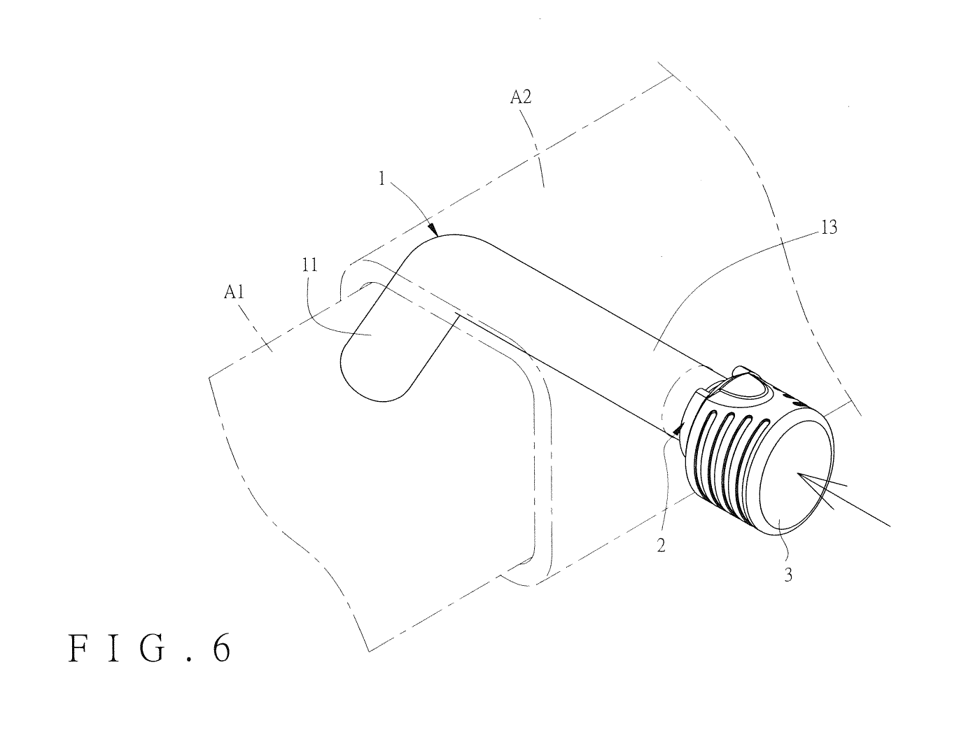

FIG. 7 is a schematic exploded view of a second embodiment of the present invention.

FIG. 8 is a schematic perspective view of the second embodiment of the present invention.

FIG. 9 is a schematic cross-sectional view of the second embodiment of the present invention, taken along the line IX-IX in FIG. 8, wherein the wire snap is retained in the retaining groove of the hitch.

FIG. 10 is a schematic exploded view of a third embodiment of the present invention.

FIG. 11 is a schematic perspective view of the third embodiment of the present invention, wherein the locating assembly is unlocked.

FIG. 12 is a schematic perspective view of the third embodiment of the present invention, wherein the locating assembly is locked.

FIG. 13 is a schematic cross-sectional view of FIG. 12 according to the third embodiment of the present invention.

FIG. 14 is a schematic exploded view of a fourth embodiment of the present invention.

FIG. 15 is a schematic cross-sectional view of the fourth embodiment of the present invention.

FIG. 16 is a schematic exploded view of a fifth embodiment of the present invention.

FIG. 17 is a schematic cross-sectional view of the fifth embodiment of the present invention.

### DETAILED DESCRIPTION OF THE INVENTION

The invention as well as a preferred mode of use, further objectives and advantages thereof will be best understood by reference to the following detailed description of illustrative embodiments when read in conjunction with the accompanying drawings.

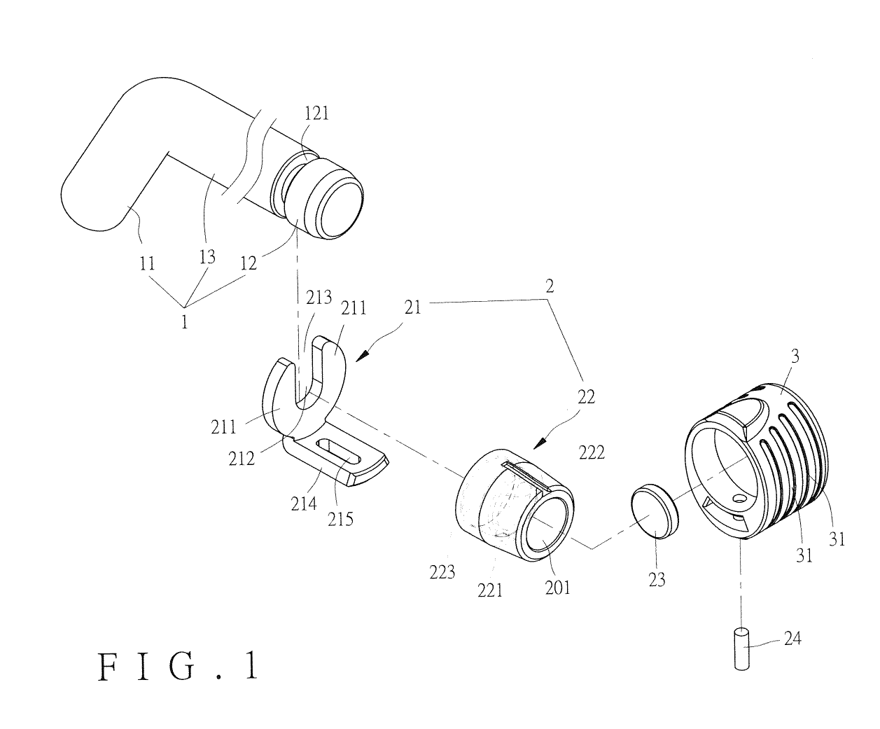

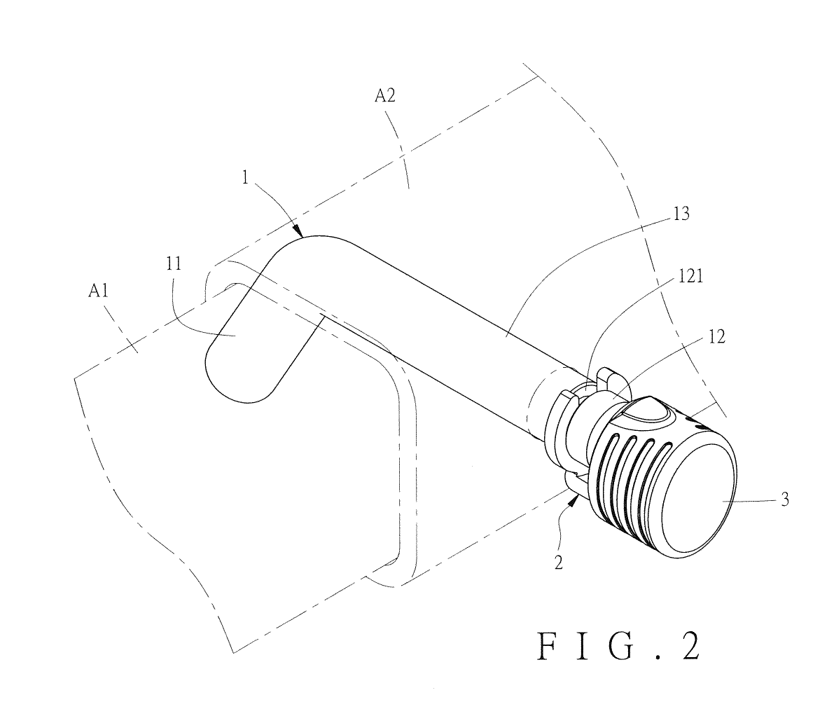

Referring to FIG. 1 and FIG. 2, in the first embodiment of the present invention, a fastening device for fastening trailer connectors comprises a hitch (1) and a locating assembly (2). The hitch (1) is configured to penetrate through a first trailer connector (A1) and a second trailer connector (A2). One of the first trailer connector (A1)) and the second trailer connector (A2) is formed on the rear of a vehicle, while the other is formed on a trailer. The locating assembly (2) includes a first locating member (21) and a second locating member (22).

The first locating member (21) is detachably connected to the hitch (1) for preventing the hitch (1) from coming off the first and second trailer connectors (A1) (A2). More particularly, the hitch (1) has a retaining portion (11), a terminal (12) and a body portion (13) that is connected between the retaining portion (11) and the terminal (12). The terminal (12) is provided with an engaging groove (121). The first locating member (21) has a pair of engaging portions (211) that define therebetween a notch (212) and an opening (213) communicated with the notch (212). Thereby, when the hitch (1) is placed into the first limiting member (21) through the opening (213) with the engaging groove (121) aligned with the notch (212), the hitch (1) is engaged with the first limiting member (21). At this time, the first limiting member (21) and the retaining portion (11) oppositely and jointly hold the hitch (1) in place with respect to the first and second trailer connectors (A1) (A2), thereby preventing unintentionally disengagement.

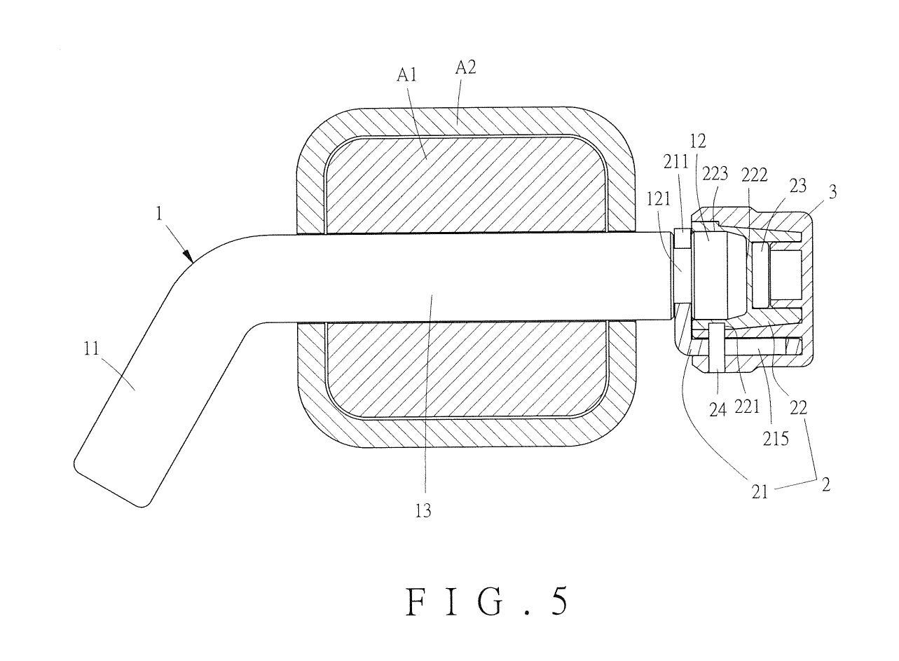

The second locating member (22) has a first combining portion (221) and a second combining portion (222). The first combining portion (221) is movably connected to the first locating member (21), so as to allow the second locating member (22) to shift between a locked position (as shown in FIG. 5) and an unlocked position (as shown in FIG. 2).

When the second locating member (22) is at the locked position, the second combining portion (222) of the second locating member (22) is fixed to the hitch (1) by a fixing member (23) and thereby holds the first locating member (21) in engagement with the hitch (1). To specify, in the present embodiment, the fixing member (23) is a magnet, and the hitch (1) is made of iron or ferrous alloy as non-limiting examples. Alternatively, the fixing member (23) may be a fastener, as long as it can hold the second locating member (22) at the locked position.

More particularly, the second locating member (22) is provided with a socket (201) that corresponds to the terminal (12) of the hitch (1) and configured to receive the magnet. However, the present invention is not limited to this aspect. Alternatively, instead of the socket (201), the second locating member (22) may have a plurality of retaining ribs to retain the magnet, as long as the implemented structure can make the magnet fixed to the second locating member (22).

Preferably, the second locating member (22) has a sleeve portion (223) that is configured to be mounted around the terminal (12) of the hitch (1), thereby holding the second locating member (22) at the locked position.

When the second locating member (22) is at the unlocked position, the second combining portion (222) of the second locating member (22) is removed from the hitch (1) and thereby allows the first locating member (21) to be detached from the hitch (1).

More particularly, the first combining portion (221) of the second locating member (22) is slidably connected to the first locating member (21) by a fixing pin (24) and can move to the unlocked position or to the locked position. To specify, the first locating member (21) has an extension portion (214) and a sliding groove (215) formed on the extension portion (214). The first combining portion (221) of the second locating member (22) is a combining hole for receiving the fixing pin (24). The fixing pin (24) is inserted into the sliding groove (215), so that the second locating member (22) can move along the extension portion (214) with the aid of the fixing pin (24). It is to be noted that in the present embodiment the fixing pin (24) and the second locating member (22) are two separate components, yet the present invention is not limited thereto. Alternatively, the fixing pin (24) may be integratedly connected to the second locating member (22).

Preferably, the fastening device further comprises a casing (3). The casing (3) is configured to be mounted around the second locating member (22) of the locating assembly (2), for shielding the fixing member (23). The casing (3) has a plurality of anti-slip portions (31) that serve to prevent the fixing member (23) from coming off the second locating member (22), and to facilitate operation and use.

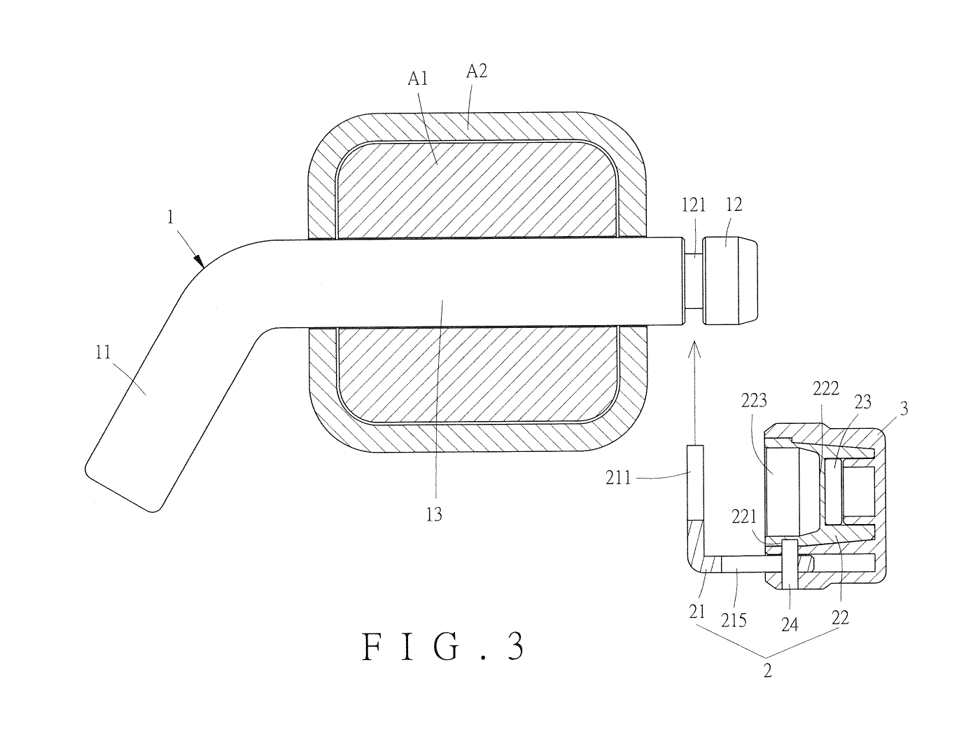

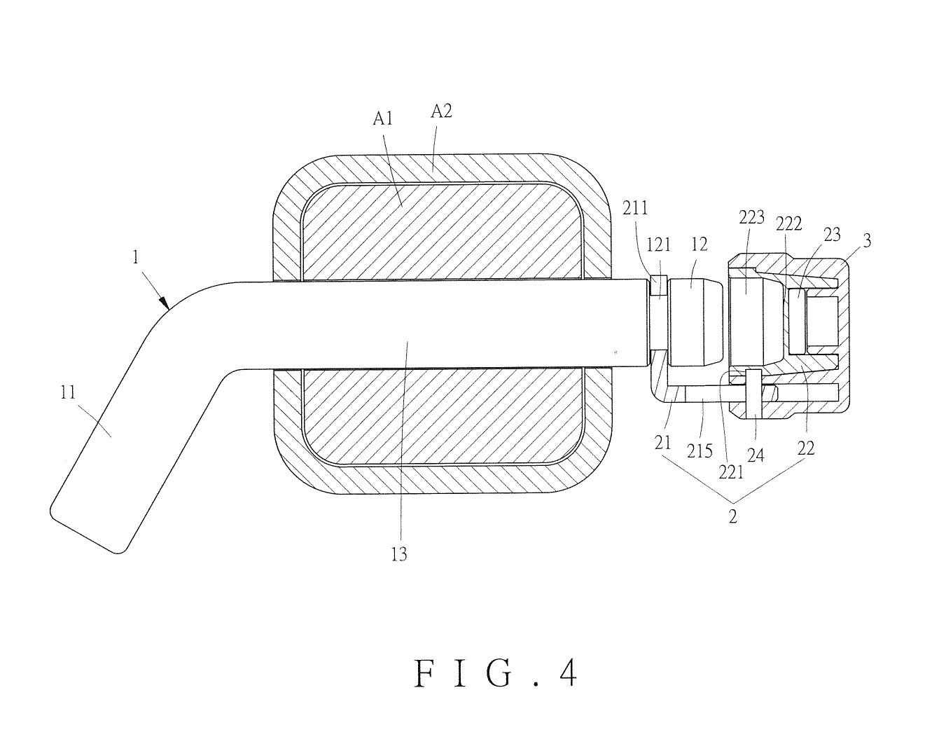

Referring to FIG. 3 and FIG. 4, for using the hitch (1) to fix the first and second trailer connectors (A1) (A2), the hitch (1) penetrates the first and second trailer connectors (A1) (A2), with the body portion (13) of the hitch (1) is embraced by the first and second trailer connectors (A1) (A2), and with the terminal (12) of the hitch (1) extends outside the first and second trailer connectors (A1) (A2). Then the engaging portion (211) of the first locating member (21) is engaged with the engaging groove (121) of the terminal (12) of the hitch (1). Subsequently, the second locating member (22) is moved toward the terminal (12) of the hitch (1) so as to be fixed to the terminal (12) of the hitch (1). Meanwhile, in one preferred embodiment the second locating member (22) also moves toward the terminal (12) of the hitch (1) under the magnet attraction of the fixing member (23). When the second locating member (22) is fixed to the terminal (12) of the hitch (1) via the fixing member (23) and therefore held at the locked position (as shown in FIG. 5), the first locating member (21), due to the connection to the second locating member (22), is held in engagement with the hitch (1). In this state, the first locating member (21) and the retaining portion (11) oppositely and jointly hold the hitch (1) in place, thereby preventing the hitch (1) from unintentionally disengaging from the first and second trailer connectors (A1) (A2).

For unlocking the engagement between the first and second trailer connectors (A1)) (A2), the second locating member (22) is removed from the terminal (12) of the hitch (1) by, for example, exerting a force to overcome the magnet attraction of the fixing member (23). When the second locating member (22) is removed from the terminal (12) of the hitch (1) and thereby reaches the unlocked position, the first locating member (21) is free to be detached from the hitch (1).

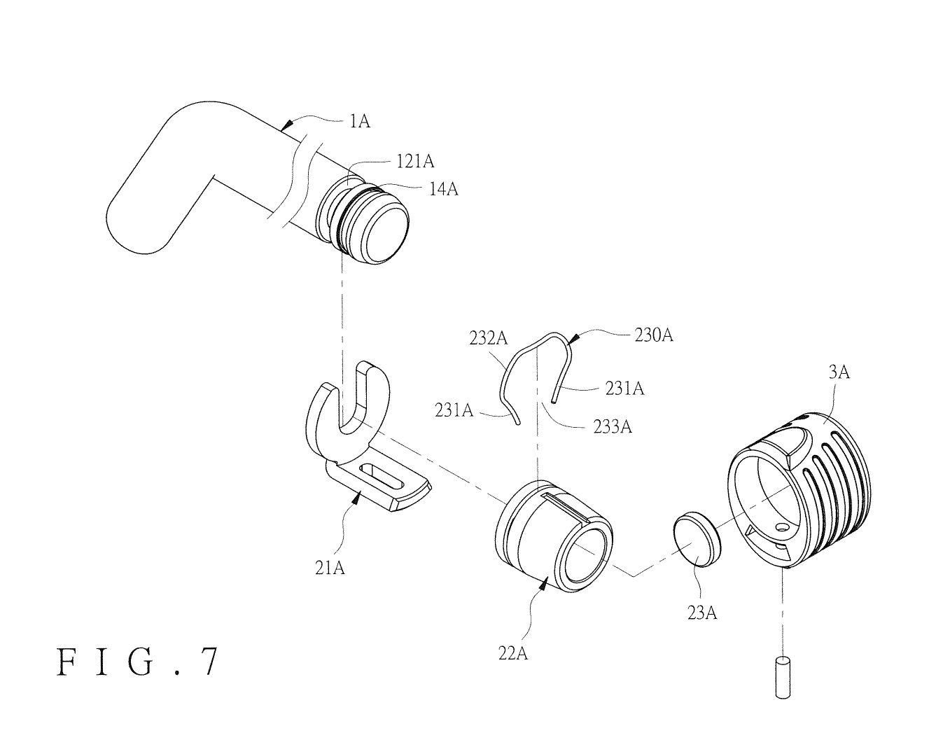

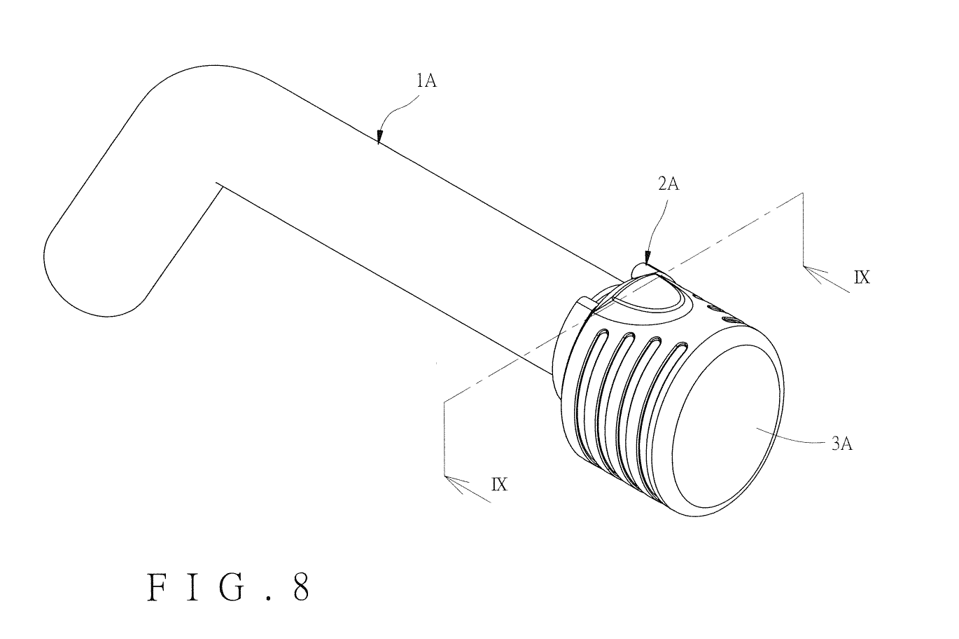

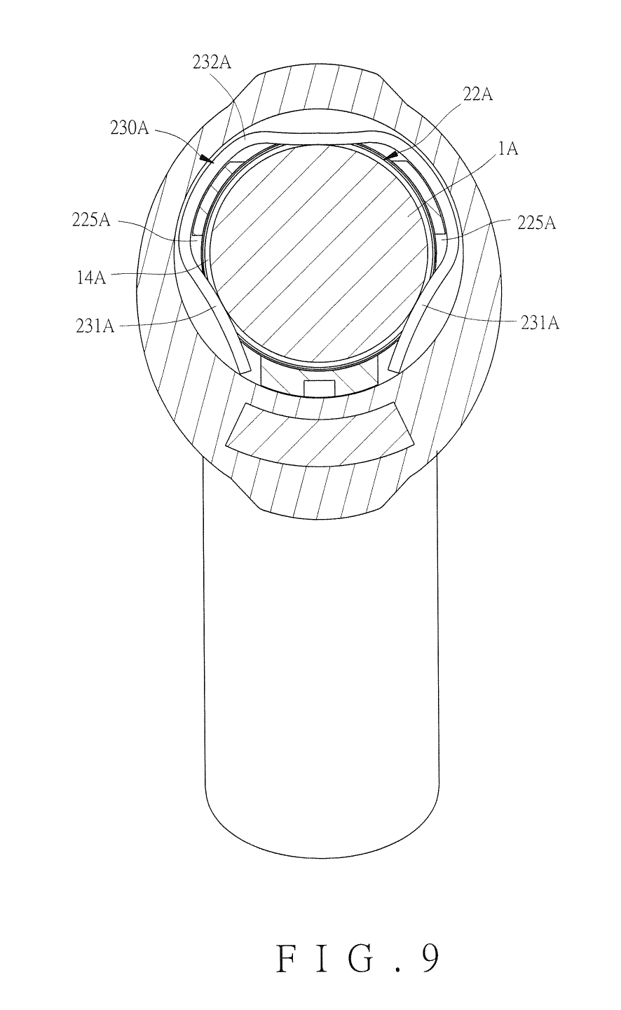

FIG. 7, FIG. 8 and FIG. 9 show the second embodiment of the present invention that is different from the first embodiment as having the following features. The hitch (1A) has a retaining groove (14A) next to the engaging groove (121A). The second locating member (22A) has a breach (225A) (as shown in FIG. 9), a first fixing member (23A) and a second fixing member (230A). Therein, the first fixing member (23A) is the magnet as described previously while the second fixing member (230A) is a wire snap. The wire snap has a pair of gripping portions (231A) and a flexible portion (232A) connected between the gripping portions (231A), so that a receiving space (233A) is defined amid the gripping portions (231A) and the flexible portion (232A) for receiving the second locating member (22A). When the second locating member (22A) is at the locked position, the gripping portions (231A) enter the retaining groove (14A) through the breach (225A) and get engaged therein, so that the first locating member (21A) is further held in engagement with the hitch (1A). The casing (3A) is similarly mounted around the second locating member (22A) for shielding the magnet and the wire snap.

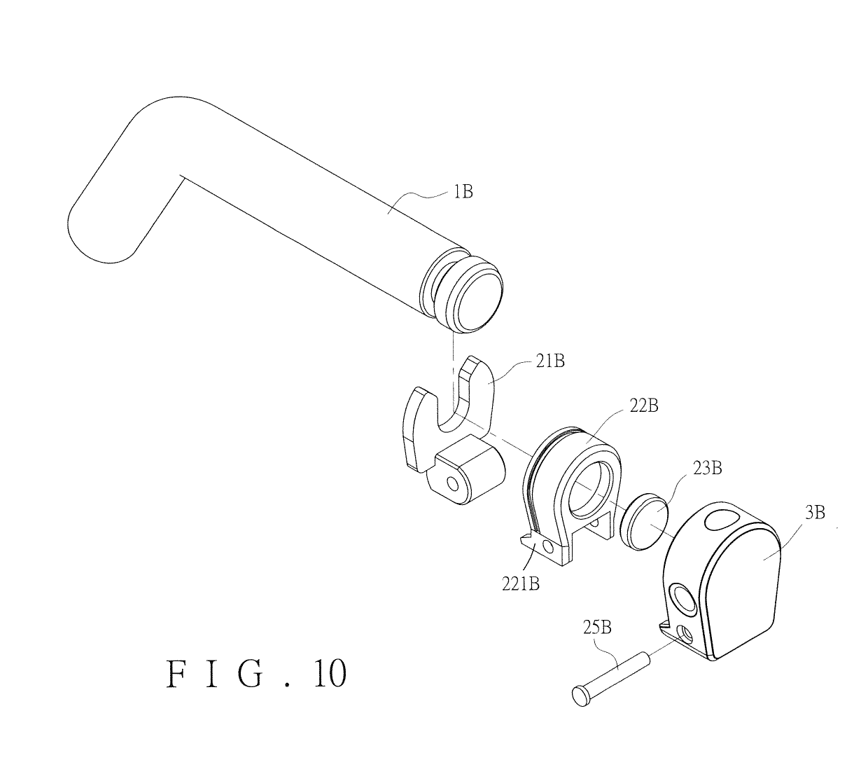

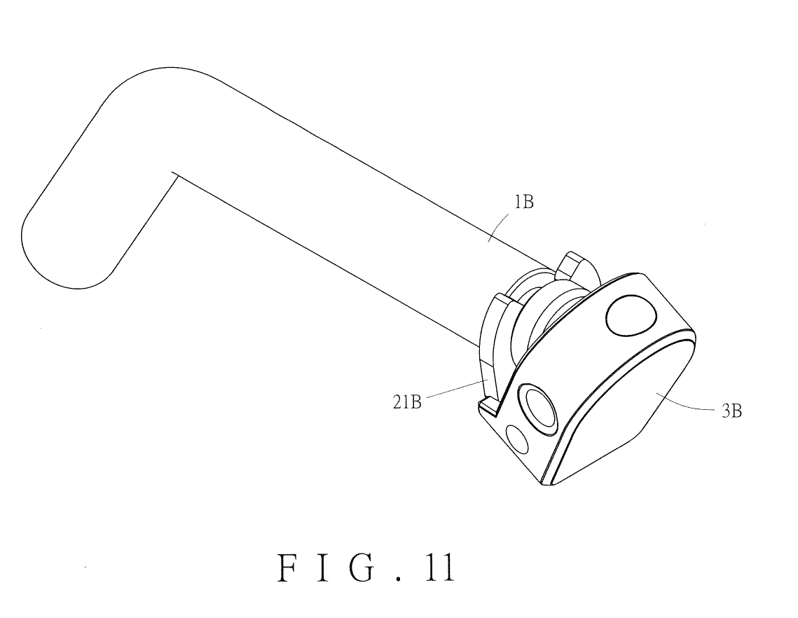

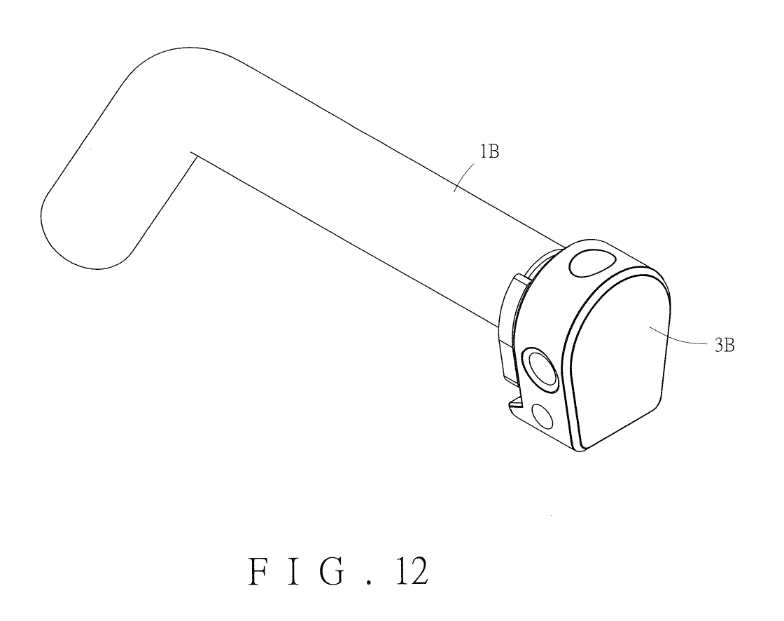

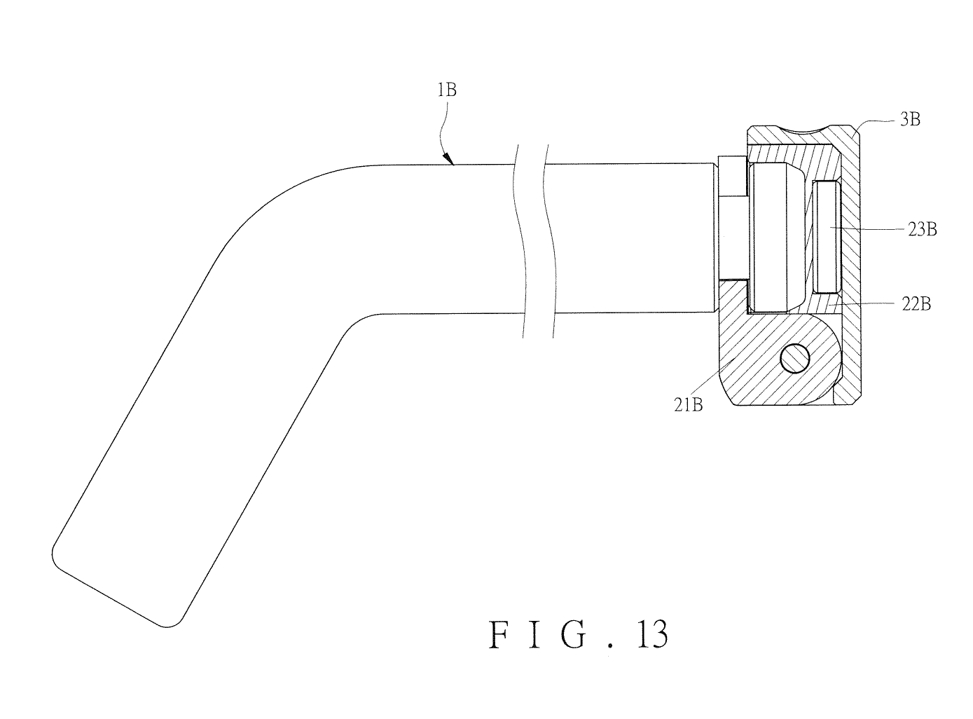

FIG. 10 depicts the third embodiment of the present invention. The third embodiment is different from the first embodiment as having the following features. The first combining portion (221B) of the second locating member (22B) and the casing (3B) are both pivotally connected to the first locating member (21B) by means of a pivot (25B), so that the second locating member (22B) can rotate to the unlocked position (as shown in FIG. 11) or to the locked position (as shown in FIG. 12). When the second locating member (22B) is rotated to the unlocked position, the first locating member (21B) is free to be detached from the hitch (1B). When the second locating member (22B) is rotated to the locked position, the fixing member (23B) is fixed to the hitch (1B) under magnet attraction, and the first locating member (21B) is thus held in engagement with the hitch (1B) (as shown in FIG. 13). It is to be noted that the second locating member (22B) may be made of a flexible and deformable material (such as plastic), so that it can deform and move to the predetermined unlocked or locked position during rotational interference. As an alternative, the mutually interfering portions of the first locating member (21B) and the second locating member (22B) can be eliminated at the design stage.

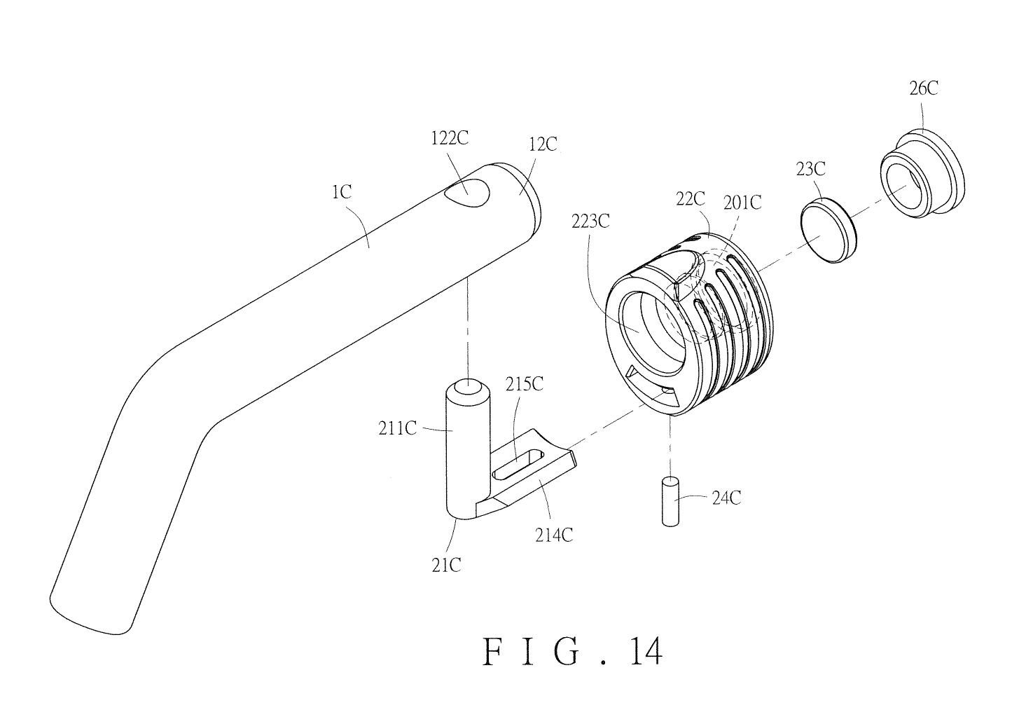

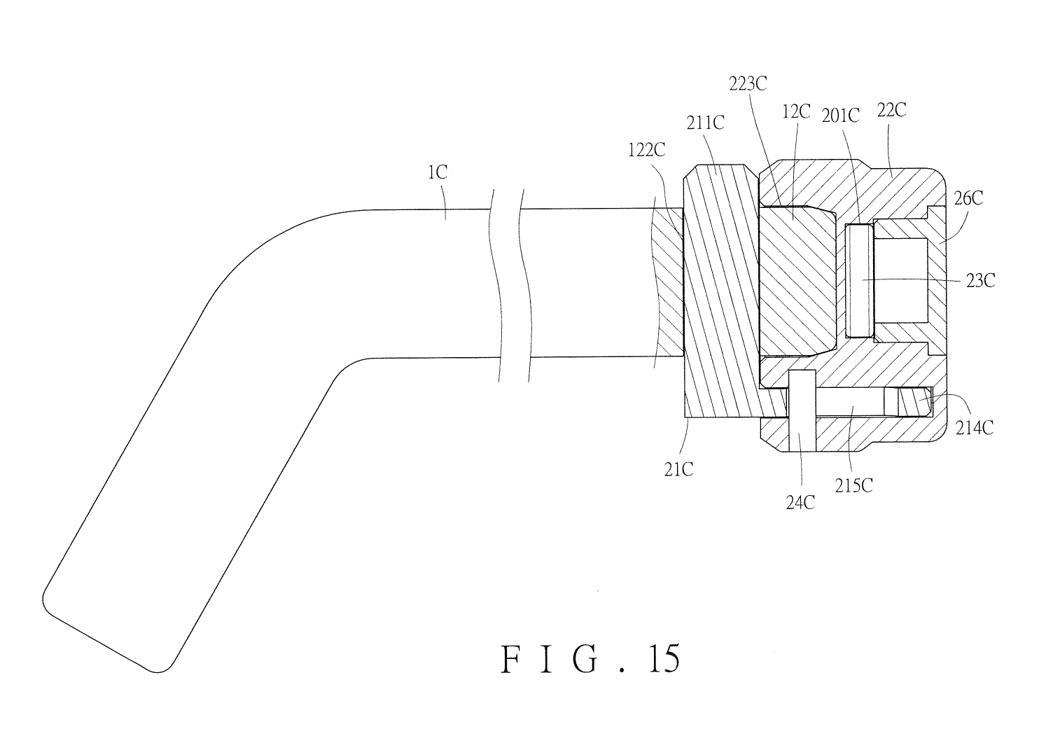

As shown in FIG. 14 and FIG. 15, the fourth embodiment of the present invention is structurally similar to the first embodiment except the following features. The hitch (1C) has its terminal (12C) provided with a through hole (122C), and the first locating member (21C) has an insertion member (211C), an extension portion (214C) connected to the insertion member (211C), and a sliding groove (215C) formed on the extension portion (214C). The insertion member (211C) is configured to be inserted into the through hole (122C), so as to make the hitch (1C) and the first locating member (21C) engaged with each other. The second locating member (22C) is movably connected to the first locating member (21C) by a fixing pin (24C). More specifically, the fixing pin (24C) enters the sliding groove (215C) of the first locating member (21C), so as to allow the second locating member (22C) to move along the first locating member (21C) within a limited range. In addition, the second locating member (22C) has the appearance as the casing of the first embodiment, and has its one end formed with a socket (201C), which corresponds to the sleeve portion (223C), for receiving the fixing member (23C). The socket (201C) is covered by a cover (26C), so as to retain the fixing member (23C). Thereby, the fixing member (23C) is also installed as desired.

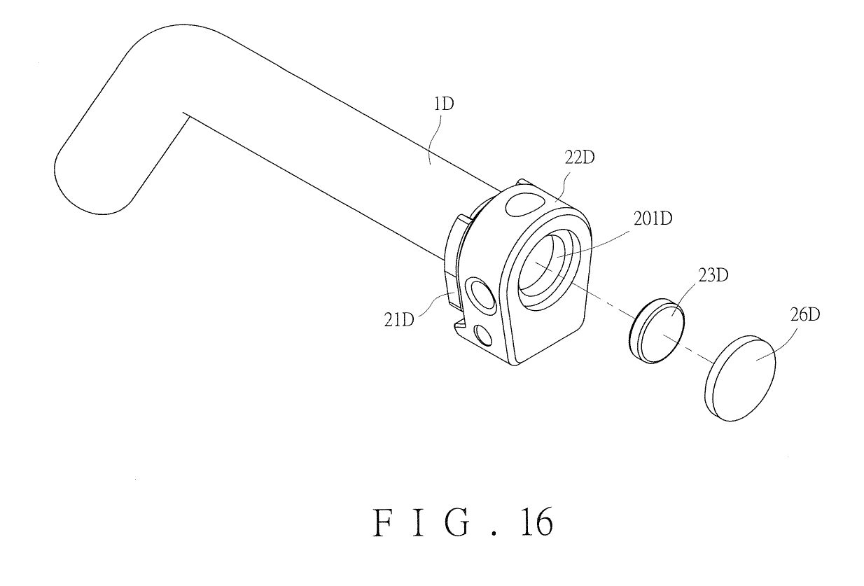

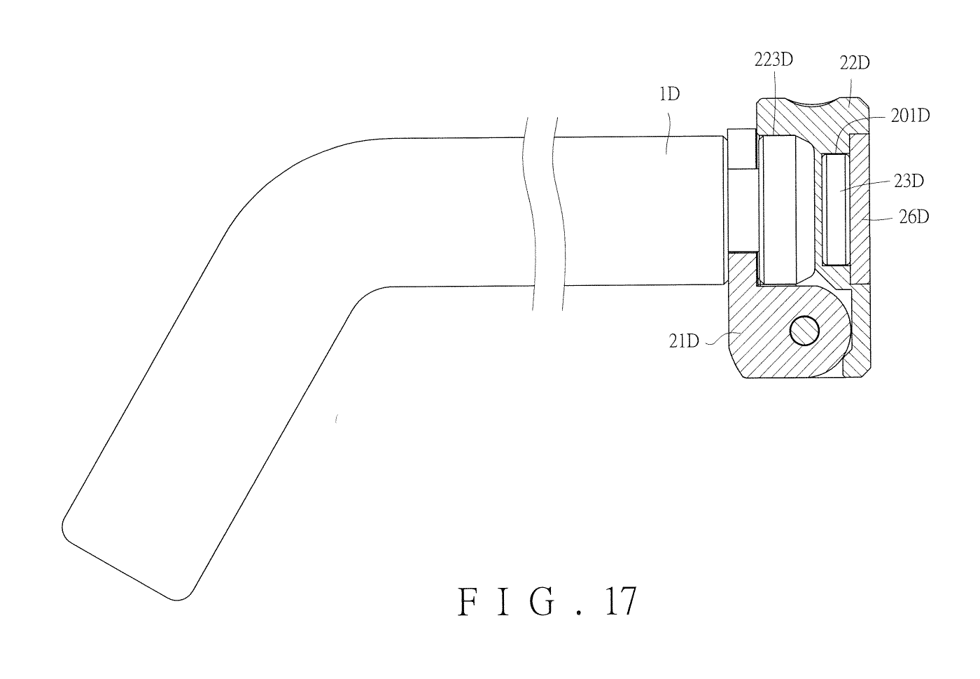

Referring to FIG. 16 and FIG. 17, the fifth embodiment of the present invention is structurally similar to the second embodiment except the following features. The second locating member (22D) has the appearance as the casing of the second embodiment and has its one end provided with a socket (201D), which corresponds to the sleeve portion (223D), for receiving the fixing member (23D). The socket (201D) is covered by a cover (26D), so as to retain the fixing member (23D). Thereby, the fixing member (23D) is also installed as desired. As the hitch (1D) and the first locating member (21D) are similar to their counterparts in the second embodiment, the detailed description is omitted herein.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A fastening device for fastening trailer connectors, comprising:
a hitch, being configured to penetrate the trailer connectors; and
a locating assembly, including a first locating member and a second locating member, the first locating member being detachably connected to the hitch for preventing the hitch from coming off the trailer connectors, the second locating member having a first combining portion and a second combining portion, the first combining portion being movably connected to the first locating member by a fixing pin, so as to allow the second locating member to shift between a locked position and an unlocked position,
wherein when the second locating member is at the locked position, the second combining portion of the second locating member is fixed to the hitch by a fixing member and thereby holds the first locating member in engagement with the hitch, and
wherein when the second locating member is at the unlocked position, the second combining portion of the second locating member is removed from the hitch and thereby allows the first locating member to be detached from the hitch.

2. The fastening device of claim 1, wherein the hitch is provided with an engaging groove, and the first locating member of the locating assembly is provided with a pair of engaging portions that define therebetween a notch and an opening communicated with the notch, so that when the hitch is placed into the first locating member through the opening with the engaging groove aligned with the notch, the hitch is engaged with the first locating member.

3. The fastening device of claim 1, wherein the hitch includes a terminal, and the second locating member of the locating assembly includes a sleeve portion that is configured to be mounted around the terminal of the hitch and thereby hold the second locating member at the locked position.

4. The fastening device of claim 1, wherein the fixing member is a fastener or a magnet.

5. The fastening device of claim 1, wherein the hitch has a retaining groove; the second locating member has a breach and the fixing member, in which the fixing member is a wire snap; the wire snap has a pair of gripping portions and a flexible portion that is connected between the gripping portions, so that a receiving space is defined amid the gripping portions and the flexible portion for fittingly receiving the second locating member; and when the second locating member is at the locked position, the gripping portions enter the retaining groove through the breach to get engaged therein.

6. The fastening device of claim 5, wherein the locating assembly further comprises a casing that is configured to be mounted around the second locating member for shielding the wire snap.

7. The fastening device of claim 6, wherein the casing is provided with a plurality of anti-slip portions.

8. The fastening device of claim 3, wherein the fixing member is a magnet, and the second locating member has one end formed with a socket for receiving the fixing member, in which the socket corresponds to the sleeve portion and is covered by a cover for retaining the fixing member.

9. The fastening device of claim 1, wherein the terminal of the hitch is provided with a through hole, and the first locating member has an insertion member that is configured to be inserted into the through hole, thereby engaging the hitch with the first locating member.

10. A fastening device for fastening trailer connectors which are penetrated by a hitch, the fastening device including:
a first locating member, being detachably connected to the hitch for preventing the hitch from corning off the trailer connectors; and
a second locating member, having a first combining portion and a second combining portion, the first combining portion being movably connected to the first locating member, so as to allow the second locating member to shift between a locked position and an unlocked position,
wherein when the second locating member is at the locked position, the second combining portion of the second locating member is fixed to the hitch by a fixing member and thereby holds the first locating member in engagement with the hitch, and
wherein when the second locating member is at the unlocked position, the second combining portion of the second locating member is removed from the hitch and thereby allows the first locating member to be detached from the hitch.
